(19) United States
(12) Patent Application Publication
(10) Pub. No.: US 2024/0110645 A1
(43) Pub. Date: Apr. 4, 2024

(54) A FIRE COLLAR

(71) Applicant: IG6 Pty Ltd, Capalaba (QLD) (AU)

(72) Inventor: Benjamin James VARDY, Tingalpa (QLD) (AU)

(21) Appl. No.: 18/038,571

(22) PCT Filed: Nov. 24, 2021
(86) PCT No.: PCT/AU2021/051406

§ 371 Date: May 24, 2023

(30) Foreign Application Priority Data
Nov. 24, 2020 (AU) 2020904349

(51) Int. Cl. F16L 5/04; A62C 2/06; E04B 1/94; H02G 3/04; H02G 3/22

(52) U.S. Cl. CPC F16L 5/04; A62C 2/065; E04B 1/947; H02G 3/0412; H02G 3/22

(57) ABSTRACT

This invention relates to a fire collar (10). The fire collar includes a body (11) that is constructed from a flexible, elongate strip of steel (12) having a first end portion (13) associated with one end thereof and an opposing second end portion (14) associated with the opposite end thereof. The fire collar (10) also includes actuation means, including a plurality of torsion springs (28) manufactured from spring steel, such as spring steel having a diameter of 4 mm or 5 mm. Each torsion spring (28) includes a spring body (29) comprising one or more helical coils, and two tails, (30) and (31), that extend outwardly away from opposite ends of the body.

This invention relates to fire collars

This invention has particular, but not exclusive, application to fire collars that may be fitted to an existing wall, including a floor or a ceiling, in which there exists a penetration through which various services, including electrical, plumbing and HVAC+R services, extend for preventing a fire, or noxious gases produced by a fire, from spreading via the penetration, and wherein reference will be made to same.

Fire collars are typically used for preventing fire spreading from one side of a wall or floor to the other side via a penetration through which pipes, ducts and other services extend.

One such fire collar includes an elongate, generally flexible, strip of material, such as galvanised steel, having a first end portion and a second end portion, and wherein each of said end portions includes connection means that may be used to releasably connect the end portions together such that the strip of material forms a generally cylindrically shaped enclosure, or bore, about one or more existing pipes, ducts or other services that extend through a penetration in a wall.

When the end portions are connected, the strip of material includes an internal face and an external face and whereby the bore includes a first opening and an opposing second opening.

The strip of material may further include a plurality of housings, that are generally equi-spaced along its length, and which are pressed from the sheet metal. Each of the housings includes two opposed side walls each having an edge in common with the strip of material and whereby said common edges in combination define an access opening. The side walls are further maintained in a spaced relationship by an intermediate rear wall such that the housings are open to the interior of the enclosure.

The fire collar also includes a thick layer of intumescent material that covers the internal face of the strip of material, including the openings to the housings, and which generally forms a cylinder when the end portions of the strip are connected together. The layer of intumescent material has an inner face and an opposing outer face, and whereby a relatively thin layer of stainless steel gauze is attached to the outer face so as to enclose the cylinder. The intumescent material is contained within the enclosure and is supported by a plurality of tabs that extend inwardly from opposed elongate edge portions of the strip of material such that the layer of stainless steel gauze presses against the internal face of the strip of material.

The fire collar also includes actuation means, such as three or more torsion springs that are each located in a respective housing. Each torsion spring includes two elongate, substantially straight, tails and whereby one tail, hereinafter referred to as the actuating tail, of each spring in use is capable of moving from a non-operating mode proximal to the layer of intumescent material to an operating mode in which it extends partially across the bore. Further, each of the actuating tails includes a distal end portion or tip, and whereby the actuating tails are configured such that when they reach the extremity of their operating mode, the tips of the respective actuating tails touch, or so nearly touch.

Further, when each of the actuating tails approaches the extremity of their operating mode, such that they extend partially across the bore so as to meet, or so nearly meet, in the centre, and because the heat effected pipe is easily deformed by the forces applied thereto by the actuating tails as they move from their non-operating mode towards the extremity of their operating mode, the layer of intumescent material shall, as it moves towards the centre of the bore, will crush, and possibly sever, the softened pipe and, as a consequence, cover the newly deformed section of the crushed pipe.

As the temperature of the ambient air increases, the intumescent material will then expand so as to fully close both the bore and the pipe, and shall form a thick solid plug that is contained within the bore and which also surrounds the deformed section of the pipe that is contained within the fire collar, thereby preventing the passage therethrough of flames, heat and hot gases. A portion of the plug, namely the expanded intumescent material will be sandwiched between the deformed section of the pipe and the stainless steel mesh by the actuating tails.

Further, it has been observed that the density of the expanded intumescent material is such that it does not readily conduct or radiate heat sufficient to start a fire on the other side of the wall.

However, fire collars of the type described are generally not suitable for closing a penetration in a wall through which there extends a cluster of plastics coated copper wires, such as communication cables. This is because the tips of the tails, upon striking the wire cables, cease moving towards the centre of the bore and, because the edge portion of the layer of intumescent material adjacent the tips of the actuating tails does not closely envelop the cluster of wires, gaps may exist, at least temporarily, between the edge of the intumescent material and the cluster of wires, through which heat, smoke and noxious gases may pass. Further, this gap may not be closed entirely as the intumescent material expands due to a rise in the ambient temperature caused by the fire. Consequently, the fire collar may not prevent the fire from spreading from one side of the wall to the other via the penetration.

It is therefore an object of the present invention to provide a fire collar which will alleviate at least some of the disadvantages of the prior art.

With the foregoing and other objects in view, this invention relates to a fire collar that may be secured to a wall in which there exists a penetration through which services, such as a cluster of plastic coated copper wires and/or metal tubes, extend so as to prevent flames, hot air and/or smoke generated by a fire situated on a side of the wall opposite to that on which the fire collar is located, having passed through the penetration, from spreading beyond the fire collar, said fire collar including:
a body having an open ended passage, such as a bore, that includes a first opening and an opposing second opening through which the services in use shall extend, said passage having an internal face;
mounting means, associated with said body for mounting said body to the wall in the vicinity of the penetration;
a layer or a segment of intumescent material located within said passage such that it at least overlies said internal face;
a layer of a protective material that extends about said segment of intumescent material and interposed between said intumescent material and said internal face;
retaining means for retaining said intumescent material in close proximity to said internal face, and
actuation means, including a plurality of torsion springs operatively connected to said body, each of said torsion springs having a spring body and two tails, including an elongate first tail, and whereby each of said first tails in use is capable of moving from a non-operating mode proximal to the layer of intumescent material to an operating mode in which it extends into said passage and wherein the spring force will be sufficiently strong enough that due to the action of said first tails, said mesh and said layer of intumescent material will form a ligature around the services.

The spring force may lie within the range of 120 N to 220 N. Preferably, the spring force is in the order of 180 N.

It is envisaged that in use, the first opening shall be located adjacent the penetration and that the second opening will be remote from the penetration, and wherein each spring will include a spring body and wherein the two tails will extend away from opposite ends of said spring body. Further, the first tail shall include a tip that is spaced remote from the body of the torsion spring and that the tip will be located adjacent, or in close proximity to, the second opening. Preferably the distance separating the first opening from the second opening is approximately the same size as the internal diameter of the bore. More preferably, the distance separating the first opening from the second opening is greater than the internal diameter of the bore.

Similarly, if the body of each torsion spring is located adjacent, or in close proximity to the first opening, then preferably the length, or operative length, of the elongate tail, or first tail, is approximately the same size as the internal diameter of the bore. More preferably, the length, or the operative length, of the elongate tail, or first tail, is greater than the internal diameter of the bore.

In another aspect, this invention relates to a fire collar that may be secured to a wall in which there exists a penetration through which services, such as a cluster of plastic coated copper wires and/or metal tubes, extend so as to prevent flames, hot air and/or smoke generated by a fire situated on a side of the wall opposite to that on which the fire collar is located, having passed through the penetration, from spreading beyond the fire collar, said fire collar including:
a body having an open ended passage, such as a bore, that includes a first opening and an opposing second opening through which the services in use shall extend, said passage having an internal face;
mounting means, associated with said body for mounting said body to the wall in the vicinity of the penetration;
a layer or a segment of intumescent material located within said passage such that it at least overlies said internal face;
a layer of a protective material that extends about said segment of intumescent material and interposed between said intumescent material and said internal face;
retaining means for retaining said intumescent material in close proximity to said internal face, and
actuation means, including a plurality of torsion springs operatively connected to said body, each of said torsion springs having a spring body and two tails, including an elongate first tail having a tip that is spaced remote from said spring body, and whereby said first tail of each spring in use is capable of moving from a non-operating mode proximal to the layer of intumescent material to an operating mode in which it extends into said passage and wherein the spring force will be sufficiently strong enough that said tips will be able to push apart at least an outer layer of services before becoming imbedded deeper within the cluster.

Preferably the tails are substantially straight. However, in other embodiments, they may include one or more bends so as to broaden the area by which they contact the layer of intumescent material.

The spring force may lie within the range of 120 N to 220 N. Preferably, the spring force is in the order of 180 N.

Preferably the length of said first tails is such that, upon actuation, the tails will move to a second operative position wherein each tail shall extend from one side of the passage to almost an opposing side of the passage.

In yet another aspect, this invention relates to a fire collar that may be secured to a wall in which there exists a penetration through which services, such as a cluster of plastic coated copper wires, extend so as to prevent flames, hot air and/or smoke generated by a fire situated on a side of the wall opposite to that on which the fire collar is located, having passed through the penetration, from spreading beyond the fire collar, said fire collar including:
a body having an open ended passage, such as a bore, that includes a first opening and an opposing second opening through which the services in use shall extend, said passage having an internal face;
mounting means, associated with said body for mounting said body to the wall in the vicinity of the penetration;
a layer or a segment of intumescent material located within said passage such that it at least overlies said internal face;
a layer of a protective material that extends about said segment of intumescent material and interposed between said intumescent material and said internal face;
retaining means for retaining said intumescent material in close proximity to said internal face, and
actuation means, including a plurality of torsion springs operatively connected to said body, each of said torsion springs including two elongate tails and whereby a first tail of each spring in use is capable of moving from a non-operating mode proximal to the layer of intumescent material to an operating mode in which it extends into said passage and wherein said torsion springs are configured such that the projected paths of said first tails will criss-cross one another, and whereby, upon actuation, said first tails will push said intumescent material into contact with said services.

Preferably the tails are substantially straight. However, in other embodiments, they may include one or more bends so as to broaden the area by which they contact the layer of intumescent material.

The spring force may lie within the range of 120 N to 220 N. Preferably, the spring force is in the order of 180 N.

The passage may be generally cylindrical and may include a generally circular shape transverse cross-sectional shape. However, it will be appreciated that in other embodiments the cross-sectional shape of the passage may be rectangular in shape, including square shaped.

The body may be of unitary construction, or of substantially unitary construction. For example, the body may be manufactured from a plastics material using an injection moulding process.

However, it will be understood that, in other embodiments, the body may comprise two or more segments that may be connected together, side by side, so as to form an enclosure around the services. For example, the sections may be integrally formed and connected to one another along a common fold line. Further, the body may include opposing end portions each having connection means for connecting the end portions together.

In yet another embodiment, the body may be both elongate and flexible, and may include two opposing end portions that may be connected together so as form an enclosure around the services.

In still yet another aspect, this invention relates to a fire collar that may be secured to a wall in which there exists a penetration through which services, such as a cluster of plastic coated copper wires, extend so as to prevent flames, hot air and/or smoke generated by a fire situated on a side of the wall opposite to that on which the fire collar is located, having passed through the penetration, from spreading beyond the fire collar, said fire collar including:
a body consisting of a long, flat, strip of a flexible material having a first end portion and an opposing second end portion;
connection means associated with said first and second end portions for connecting said end portions together such that said body generally resembles a cylinder having an open ended bore that includes a first opening and an opposing second opening and wherein said cylindrically shaped body includes a broad internal face and an opposing external face;
mounting means, associated with said body for mounting said cylindrically shaped body to the wall in the vicinity of the penetration such that the cluster of wires extend through said bore;
a layer of a segment of intumescent material located within said bore that at least overlies a substantial portion of said internal face;
a layer of a protective material that extends about said segment of intumescent material and interposed between said intumescent material and said internal face;
retaining means for retaining said intumescent material in close proximity to said internal face, and
actuation means, including a plurality of torsion springs operatively connected to said body, each of said torsion springs having a spring body and two tails, including an including first tail and whereby said first tail of each spring in use is capable of moving from a non-operating mode proximal to the layer of intumescent material to an operating mode in which it extends into said passage and wherein the spring force will be sufficiently strong enough that said tips will be able to push apart at least an outer layer of wires before becoming imbedded deeper within the cluster.

The second tail need not be of the same length as the first tail. However, it is preferred that the tails are both elongate and substantially straight. However, in other embodiments, they may include one or more bends so as to broaden the area by which they contact the layer of intumescent material.

The free ends, or tips, of the first and second tail of each torsion spring may be temporarily retained close to one another by a fusible link and wherein the fusible link may be designed to break when the temperature in the vicinity of the fire collar reaches a predetermined temperature.

The spring force may lie within the range of 120 N to 220 N. Preferably, the spring force is in the order of 180 N.

Preferably the length of said first tails is such that, upon actuation, the tails will move to a second operative position wherein each tail shall extend from one side of the passage to almost an opposing side of the passage.

In still yet another aspect, this invention relates to a fire collar that may be secured to a wall in which there exists a penetration through which services, such as a cluster of plastic coated copper wires, extend so as to prevent flames, hot air and/or smoke generated by a fire situated on a side of the wall opposite to that on which the fire collar is located, having passed through the penetration, from spreading beyond the fire collar, said fire collar including:
a body consisting of a long, flat, strip of a flexible material having a first end portion and an opposing second end portion;
connection means associated with said first and second end portions for connecting said end portions together such that said body generally resembles a cylinder having an open ended bore that includes a first opening and an opposing second opening and wherein said cylindrically shaped body includes a broad internal face and an opposing external face;
mounting means, associated with said body for mounting said cylindrically shaped body to the wall in the vicinity of the penetration such that the cluster of wires extend through said bore;
a layer of a segment of intumescent material located within said bore that at least overlies a substantial portion of said internal face;
a layer of a protective material that extends about said segment of intumescent material and interposed between said intumescent material and said internal face;
retaining means for retaining said intumescent material in close proximity to said internal face, and
actuation means, including a plurality of torsion springs operatively connected to said body, each of said torsion springs having a spring body and two tails, including an elongate first tail, and whereby said first tails are each capable of moving from a non-operating mode proximal to the layer of intumescent material to an operating mode in which it extends into said passage and wherein said torsion springs are configured such that the projected paths of said first tails will criss-cross one another, and whereby, upon actuation, said first tails will push said intumescent material into contact with said services.

The second tail need not be of the same length as the first tail. However, it is preferred that the tails are both elongate and substantially straight. However, in other embodiments, they may include one or more bends so as to broaden the area by which they contact the layer of intumescent material.

The spring force may lie within the range of 120 N to 220 N. Preferably, the spring force is in the order of 180 N.

The body may be constructed from a metal material, such as galvanised steel. In one embodiment, the body is constructed from a continuous strip of metal. However, in other embodiments, the body may include a plurality of individual links that are connected end to end.

The retaining means may be formed integrally with the body. For example, the retaining means may include a plurality of tabs or barbs and whereby these tabs and barbs may be punched out of selected portions of the body in the vicinity of the first and second openings. Alternatively, the tabs or barbs may extend outwardly away from a respective peripheral edge portion of the body.

Alternatively, the retaining means may be separate from the body. For example, the retaining means may include a plurality of clips.

The connection means may be formed integrally with the body, For example, in one end portion there may be formed one or more hook like projections that are adapted to engage respective openings formed in the other end portion of the body.

Alternatively, the connection means may be constructed separately from the body and may include at least two components that are adapted to mechanically engage with one another and wherein the components may be attached to respective end portions of the body. For example, the connection means may include a latch assembly.

The torsion springs may each be located within a respective housing that is open to the interior of said bore and wherein the housing may include side walls that are attached to or pressed out of the body.

Preferably the torsion springs are made from a suitable metal material, such as spring steel. Further, it is preferred that each of the torsion springs includes a body comprising one or more helical coils, and two tails that extend outwardly away from opposite ends of the body.

Preferably, each torsion spring is supported in an operative position by a pin, or something that functions like a pin, that extends through the body and which may further extend through and be supported by an aperture in a side wall of the housing.

The tail of the torsion spring that is required to move from a non-operational position to an operational position may be retained in its non-operational position by a sacrificial component, such as a fusible link connecting the tail to the other tail of the torsion spring, and whereby destruction of the sacrificial component will permit the tail to move in the direction of the intumescent material and thereby force it across the bore.

Typically, the fusible link is formed from a plastics material which softens to a fusible state upon the ambient temperature reaching a predetermined temperature at which the spring causes it to break. In such form, the fusible link holds the tail of the spring in the “loaded” position, that is in a position with the spring wound sufficiently to apply a suitable force to the intumescent material.

Preferably the fire collar includes a plurality of actuation means and wherein the actuation means may be equi-angularly spaced around the bore of the assembled fire collar.

Preferably, a layer of protective material extends about the layer or segment of intumescent material to protect it from damage by the actuation means as it softens pursuant to an increase in temperature. Thus, reference to engagement of the intumescent material by the actuation means is to be understood as encompassing engagement with a layer of the other material which might be interposed between the actuation means and the intumescent material, for example a layer of stainless steel gauze or fibreglass cloth.

The mounting means may be formed integrally with the body and may include tabs that extend outwardly from a peripheral edge portion of the body and wherein each tab may include an aperture through which a fastener may extend.

Alternatively, the mounting means may be separate from the body and attached thereto. For example, the mounting means may include a first flange that may be secured to a wall portion of the body, such as a side wall of a housing, and a second flange that extends outwardly away from the first flange at substantially 90 degrees and wherein the second flange may include an aperture through which a fastener may extend.

The tabs and/or flanges that in use shall abut the wall may combine one another in order to form a substantially continuous base wall that in the assembled state shall surround the bore.

In order that this invention may be more easily understood and put into practical effect, reference will now be made to the accompanying drawings wherein:

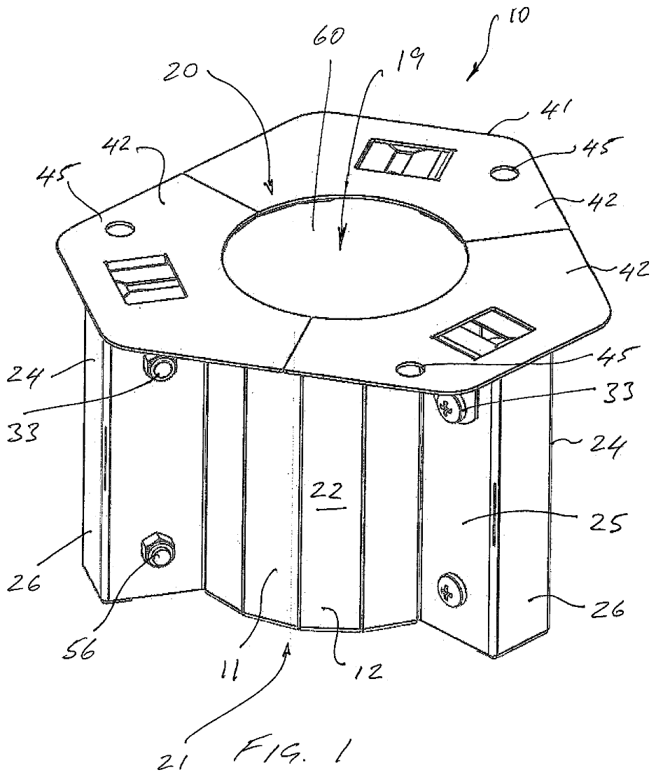

FIG. 1 is a pictorial view of one side of a fire collar that is constructed in accordance with the present invention;

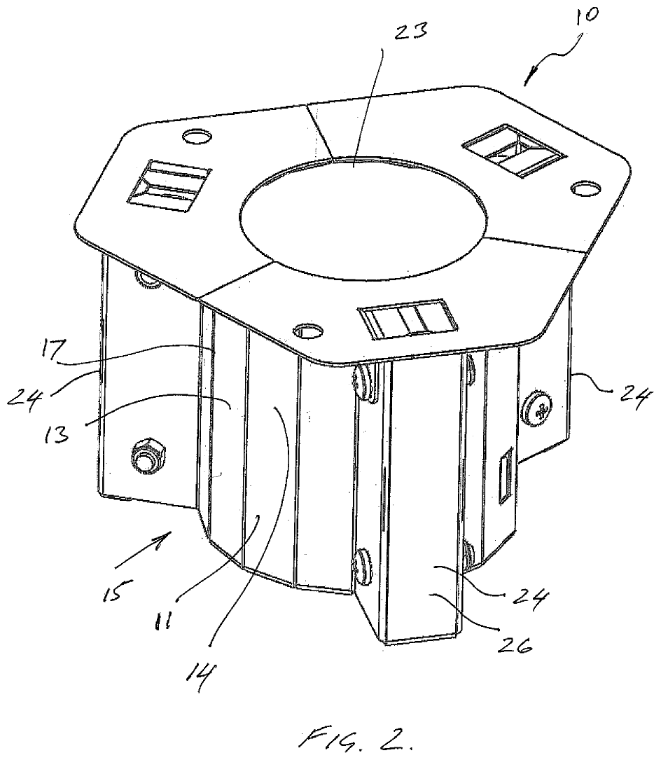

FIG. 2 is a pictorial view of another side of the fire collar shown in FIG. 1;

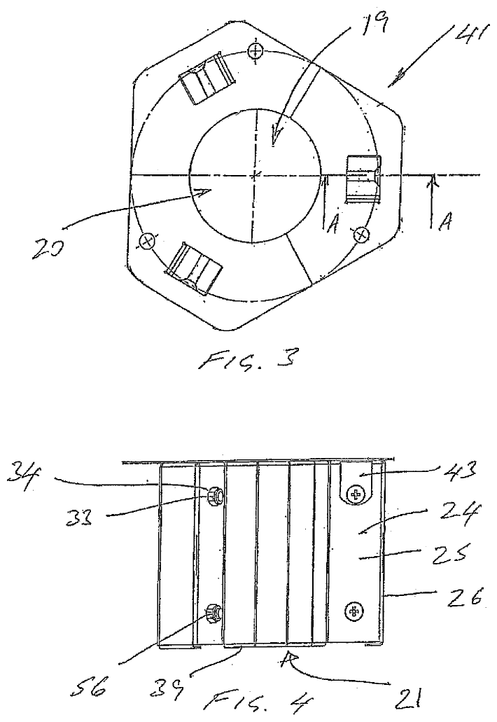

FIG. 3 is plan view of the fire collar shown in FIG. 1;

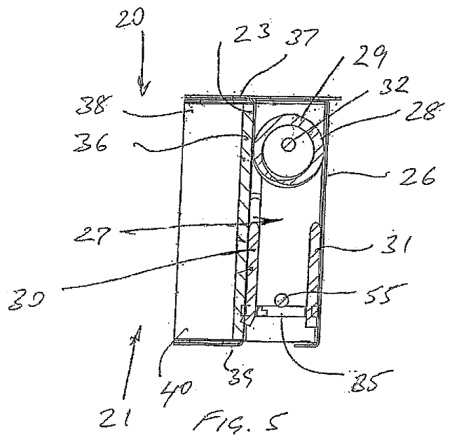

FIG. 4 is a side view of the fire collar shown in FIG. 1, and

FIG. 5 is a cross-sectional view along line A-A of the fire collar shown in FIG. 1.

FIGS. 1 to 5 show a fire collar 10 that includes a body 11 that is constructed from a flexible, elongate strip of steel 12 having a first end portion 13 associated with one end thereof and an opposing second end portion 14 associated with the opposite end thereof.

The body 11 includes connection means 15 enabling the body to be formed into a generally cylindrically shaped enclosure 16 around services that extend through a penetration in a wall, such as a cluster of plastics coated copper wires. The connection means 15 includes two tabs 17 that have been pressed out of the first end portion 13 and corresponding apertures partially created by the formation of each tab. The connection means 15 also includes two tabs 18 that have been pressed out of the second end portion 14 and corresponding apertures partially created by the formation of the tabs. The two end portions 13 and 14 may be releasably connected by engaging the tabs 17 behind a respective tab 18 and vice versa.

The enclosure 16, formed by the connection of the two end portions 13 and 14, defines an open-ended bore 19 having a first opening 20 and an opposing second opening 21, an external face 22 and an internal face 23. Further, by way of example, the diameter of the bore may be in the order of 70 mm, 120 mm or 170 mm.

The body 11 also includes three housings 24 that are formed from the strip of metal using a pressing process and which are substantially equi-spaced from one another. Each housing 24 includes two opposing side walls 25 that are maintained in a spaced relationship by an intermediate rear wall 26, and wherein the side walls 25 in combination partially define an opening 27 that is in communication with the bore 19.

The fire collar 10 also includes actuation means, including a plurality of torsion springs 28 manufactured from spring steel, such as spring steel having a diameter of 4 mm or 5 mm. Each torsion spring 28 includes a spring body 29 comprising one or more helical coils, and two tails, 30 and 31, that extend outwardly away from opposite ends of the body.

Each torsion spring 28 is supported in an operative position within a respective housing 24 by a threaded shaft 32 of a bolt 33 that extends through aligned apertures 34, in the side walls 25, and through the coiled body 29.

Each tail 30 is moveable from a non-operational position to an operational position and is retained in its non-operational position by a sacrificial component, such as a fusible link 35, connecting the tail 30 to the other tail 31, as shown in FIG. 5. The fusible link 35, rests on, or abuts against, a threaded shaft 55, of a bolt 56 that extends through aligned apertures formed in the side walls 25.

The fire collar 10 also includes a layer or segment of intumescent material of known type, typically neoprene based or high density polypropylene, formed into a cylinder 36 and enclosed by an outer layer of stainless steel gauze, not shown, is retained within the bore 19 by tabs 37 that extend inwardly from a first elongate peripheral edge portion 38 of the body and tabs 39 that extend inwardly from an opposing elongate peripheral edge portion 40, and by tabs 60 that extend inwardly from end portion 13. The tabs 37 and 39 are integral with the body 11 and are formed using a pressing process. Consequently, the outer layer of stainless steel abuts against the internal face 23 of the bore 19 and closes the openings 27 of the housings 24.

The fire collar 10 also includes mounting means 41 for mounting the body on a wall, not shown, in which there is formed a penetration through which the services extend. The mounting means includes three base plates 42 each having an upstanding tab 43 pressed therefrom, in which there is an aperture enabling the tab to be secured to a side wall 25 of a respective housing 24. Each base plate 42 includes an aperture 45 through which a fastener may extend for the purpose of securing the fire collar to the wall.

In use, the fire collar 10 is formed into a cylindrical enclosure around services that extend through a penetration in a wall, such as a cluster of plastics coated copper wires, and whereby the first end portion 13 is secured to the second end portion 14 by engaging the tabs 17 behind respective tabs 18 and vice versa. The fire collar 10 is then attached to the wall using a plurality of threaded fasteners that each extend through a respective mounting aperture 45 of a base plate 42.

In the event of a fire on the opposite side of the wall to that to which the fire collar 10 is attached, the ambient air temperature passing through the penetration shall increase causing the fusible links 35 to soften, and then break, under the force applied thereto by the tails 30 and 31 of respective torsion springs 28 (or alternatively melts).

Following the destruction of the fusible links 35, each tail 31 will engage an adjacent rear wall 26 while the opposing leg 30 will engage the layer of intumescent material and push said intumescent material in the general direction of the longitudinal axis of the bore 19. Because the spring force is strong enough for the tip of the tail to push between wires that make up the outer layer or layers of the cluster, (typically the spring force lies in the range of 120 N to 220 N, the edge portion of the layer of intumescent material adjacent the tips will closely surround and/or envelop the cluster of wires.

Further, as the ambient temperature increases, the intumescent material will expand in response to same and will melt the plastics covering the wires. Because the length of each tail 30 can extend into the bore and past the longitudinal axis and because the prospective paths of the tails 30 criss-cross, as the plastics covering the wires melts, the tails will continue to push on through the cluster thereby ensuring that the expanding intumescent material will fill any voids between the wires within the cluster and thereby form a solid plug that closes the bore, thereafter preventing hot air, flames and smoke to pass through said bore.

It will also be appreciated that the tails, mesh and intumescent material have formed a ligature around the wires, pushing them together and also protecting the metal of the wires from exposure to direct heat.

It therefore follows, the greater the distance from the wall that the ligature is applied to the metal services, the less heat is conducted into the wall, radiating out from the heated metal service to the neighbouring compartment.

Further, the springs must also be sufficiently strong that they can resist the outward pressure of the intumescent material pushing away from the cluster of wires, forcing it instead to swell into any gaps between the metal wires and into the space between the melting plastic of any cable sheaves, preventing gases passing through the middle of the services.

It has also been found, the housings containing each of the springs must be reinforced by the inclusion of bolt 56, or similar device, to prevent the side wall of the bore in the vicinity of the opening 21 from spreading apart, thus decreasing the density of the intumescent material and causing premature failure of the system.

If the collar is too short, then the heat will conduct via the metal of the service, through the penetration and into the neighbouring compartment. It will also radiate more heat into the building element, causing it to fail more quickly than would otherwise be the case. Any gases that pass through the centre of the cluster before the intumescent material has sufficiently swollen will also be more likely to pass right through the element resulting in a failure of the system.

If the springs used do not apply enough force, then they will not be able to hold against the outward pressure being applied thereto by the intumescent material as it expands and so force the intumescent material into any gaps formed by the melting of the plastic's sheaves covering the metal wires or any insulating foam that is present, and will not be able to push the cluster closer together to reduce gaps between the services. Additionally, if the springs are unable to maintain pressure, the intumescent material can be prematurely eroded as it is not as tightly packed together, and this can cause the premature failure of the system.

The foregoing description has been given by way of illustrative example of the invention and any modifications and variations which will be apparent to persons skilled in the art may be made without departing from the spirit and scope of the invention as defined in the appended claims.

1. (canceled)

2. A fire collar that may be secured to a wall in which there exists a penetration through which services, such as a cluster of plastic coated copper wires and/or metal tubes, extend so as to prevent flames, hot air and/or smoke generated by a fire situated on a side of the wall opposite to that on which the fire collar is located, having passed through the penetration, from spreading beyond the fire collar, said fire collar including:
a body having an open-ended passage, such as a bore, that includes a first opening and an opposing second opening through which the services in use shall extend, said passage having an internal face;
mounting means, associated with said body for mounting said body to the wall in the vicinity of the penetration;
a layer or a segment of intumescent material located within said passage such that it at least overlies said internal face;
a layer of a protective material that extends about said segment of intumescent material and interposed between said intumescent material and said internal face;
retaining means for retaining said intumescent material in close proximity to said internal face, and actuation means, including a plurality of torsion springs operatively connected to said body, each of said torsion springs having a spring body and two tails, including an elongate first tail having a tip that is spaced remote from said spring body, and wherein said first tail of each spring in use is capable of moving from a non-operating mode proximal to the layer of intumescent material to an operating mode in which it extends into said passage and wherein the spring force will be sufficiently strong enough that said tips will be able to push apart at least an outer layer of services before becoming imbedded deeper within the cluster.

3. (canceled)

4. The fire collar of claim 2, wherein said spring body is located adjacent, or in close proximity to, said first opening and wherein said tip is located adjacent, or in close proximity to, said second opening.

5. (canceled)

6. (canceled)

7. The fire collar of claim 4, wherein the length, or operative length of said first tail is greater than the internal diameter of said bore.

8. The fire collar of claim 19, wherein said body is elongate and flexible, and includes opposing end portions each having connection means for connecting said end portions together.

9. The fire collar claim 8, wherein said body comprises two or more segments that are connected together, side by side.

10. The fire collar of claim 9, wherein said segments are integral and are connected to an adjacent segment by a common fold line.

11. A fire collar that may be secured to a wall in which there exists a penetration through which services, such as a cluster of plastic coated copper wires, extend so as to prevent flames, hot air and/or smoke generated by a fire situated on a side of the wall opposite to that on which the fire collar is located, having passed through the penetration, from spreading beyond the fire collar, said fire collar including:
a body consisting of a long, flat, strip of a flexible material having a first end portion and an opposing second end portion;
connection means associated with said first and second end portions for connecting said end portions together such that said body generally resembles a cylinder having an open-ended bore that includes a first opening and an opposing second opening and wherein said cylindrically shaped body includes a broad internal face and an opposing external face;
mounting means, associated with said body for mounting said cylindrically shaped body to the wall in the vicinity of the penetration such that the cluster of wires extend through said open-ended bore;
a layer of a segment of intumescent material located within said open-ended bore that at least overlies a substantial portion of said internal face;
a layer of a protective material that extends about said segment of intumescent material and interposed between said intumescent material and said internal face;
retaining means for retaining said intumescent material in close proximity to said internal face; and
actuation means, including a plurality of torsion springs operatively connected to said body, each of said torsion springs having a spring body and two tails, including a first tail, and wherein said first tail of each spring in use is capable of moving from a non-operating mode proximal to the layer of intumescent material to an operating mode in which it extends into said passage and wherein a spring force will be sufficiently strong enough that said tips will be able to push apart at least an outer layer of wires before becoming imbedded deeper within the cluster.

12. The fire collar fire collar of claim 17, wherein the length of each of said first tails is such that, upon actuation, said first tails will move to a second operative position wherein they shall extend from one side of said passage to the other side of said of said passage or thereabouts.

13. (canceled)

14. The fire collar of claim 19, wherein said spring force lies within a range of 120 N to 220 N.

15. The fire collar of claim 19, wherein said spring force is approximately 180 N.

16. The fire collar of claim 11, wherein said first tail is elongate and includes a tip that is spaced remote from said spring body and which is located adjacent, or in close proximity to, said second opening.

17. The fire collar of claim 16, wherein said torsion springs are configured such that the projected paths of said first tails will crisscross one another.

18. The fire collar of claim 7, wherein said torsion springs are configured such that the projected paths of said first tails will crisscross one another.

19. The fire collar of claim 18, wherein the length of each of said first tails is such that, upon actuation, said first tails will move to a second operative position wherein they shall extend from one side of said passage to the other side of said passage or thereabouts.

20. The fire collar of claim 11, wherein said spring force lies within a range of 120 N to 220 N.

21. The fire collar of claim 11, wherein said spring force is approximately 180 N.
